(19) United States
(12) Patent Application Publication
(10) Pub. No.: US 2026/0176030 A1
(43) Pub. Date: Jun. 25, 2026

(54) ADJUSTABLE NOZZLE

(71) Applicant: SIANG SYUAN FU ENTERPRISE CO., LTD., Changhua County (TW)

(72) Inventor: Chen-Hsuan HUNG, Changhua County (TW)

(21) Appl. No.: 18/999,661

(22) Filed: Dec. 23, 2024

(51) Int. Cl. B65D 47/06

(52) U.S. Cl. CPC B65D 47/06

(57) ABSTRACT

An adjustable nozzle is provided, wherein the adjustable nozzle includes: a first member including a first body, a first channel and a first opening, the first channel extending through the first body in a first direction, the first direction being inclined relative to a direction toward which the first opening is open; and a second member including a second body, a second channel and an engaging portion, the second channel extending through the second body, the engaging portion being disposed on the second body, wherein when the second body is disposed through the first channel and protrudes out of the first opening, the second body is rotatable relative to the first body, the engaging portion is located in the first channel and interlocks with an edge of the first opening in the first direction, and the second channel is in communication with the first channel.

### BACKGROUND OF THE INVENTION

### Field of the Invention

The present invention relates to a nozzle, particularly to an adjustable nozzle.

### Description of the Prior Art

A container for containing silicone is used with a nozzle. The nozzle can control the shape, direction and flow rate of the discharged silicone, allowing the silicone to adhere to designated positions. The nozzles are, for example, disclosed in TW M459033 and TW M409106.

However, the conventional nozzles are all simple straight conical tubes. When working in narrow spaces or at corners, the large size of the caulking gun or the container often causes inconvenient in accessing the intended construction areas.

The present invention is, therefore, arisen to obviate or at least mitigate the above-mentioned disadvantages.

### SUMMARY OF THE INVENTION

The main object of the present invention is to provide an adjustable nozzle which provides a broader range of accessibility, facilitating its application in various environments.

To achieve the above and other objects, an adjustable nozzle is provided, wherein the adjustable nozzle includes: a first member including a first body, a first channel and a first opening, the first channel extending through the first body in a first direction, the first direction being inclined relative to a direction toward which the first opening is open; and a second member including a second body, a second channel and an engaging portion, the second channel extending through the second body, the engaging portion being disposed on the second body, wherein when the second body is disposed through the first channel and protrudes out of the first opening, the second body is rotatable relative to the first body, the engaging portion is located in the first channel and interlocks with an edge of the first opening in the first direction, and the second channel is in communication with the first channel.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of FIG. 1;

FIG. 3 is a top view of FIG. 1;

FIG. 4 is a cross-sectional view of FIG. 1;

FIG. 5 is an exploded view of FIG. 4;

FIG. 6 is a drawing showing an operation of an exemplary embodiment of the present invention;

FIG. 7 is a drawing showing adjustment of an exemplary embodiment of the present invention; and

FIG. 8 is a cross-sectional view of FIG. 7.

### DETAILED DESCRIPTION OF THE PREFERRED EMBODIMENTS

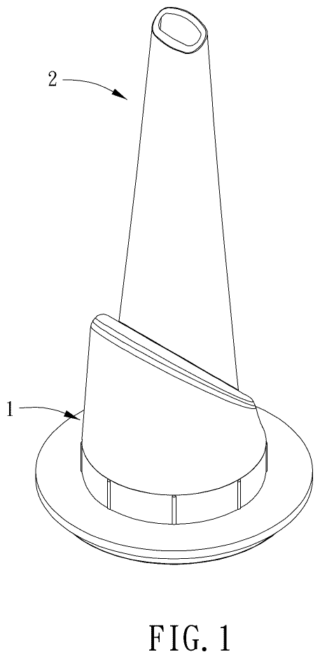

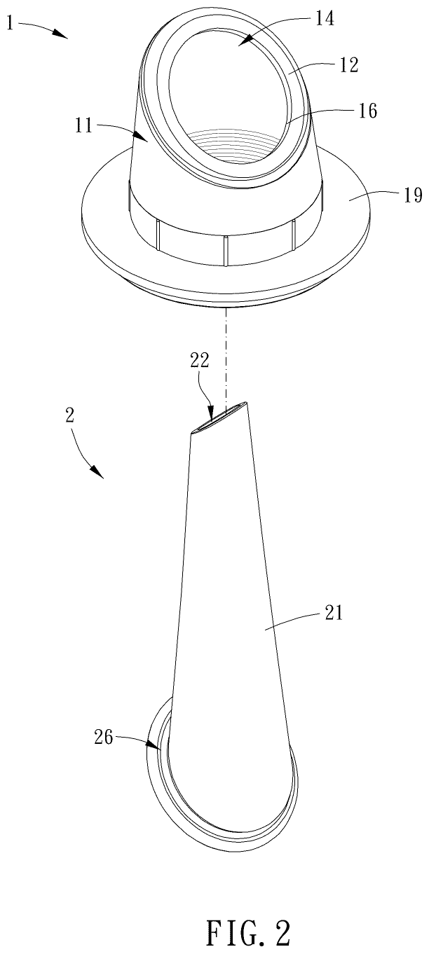

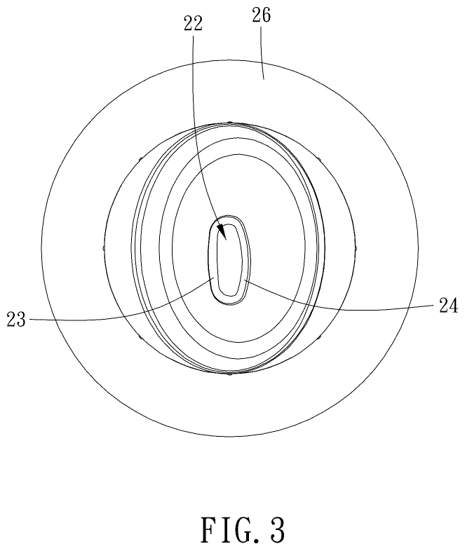

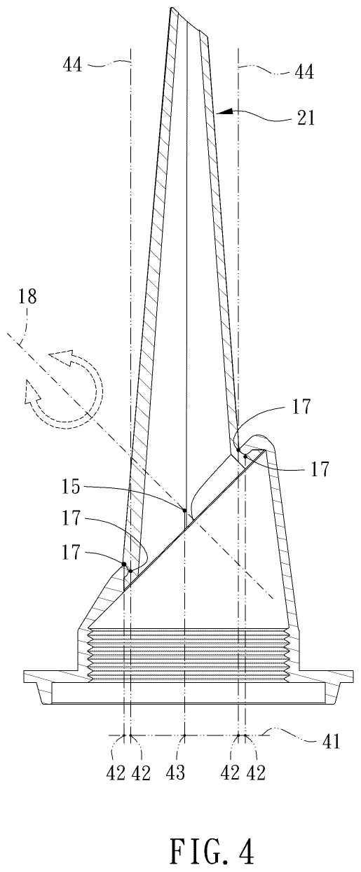

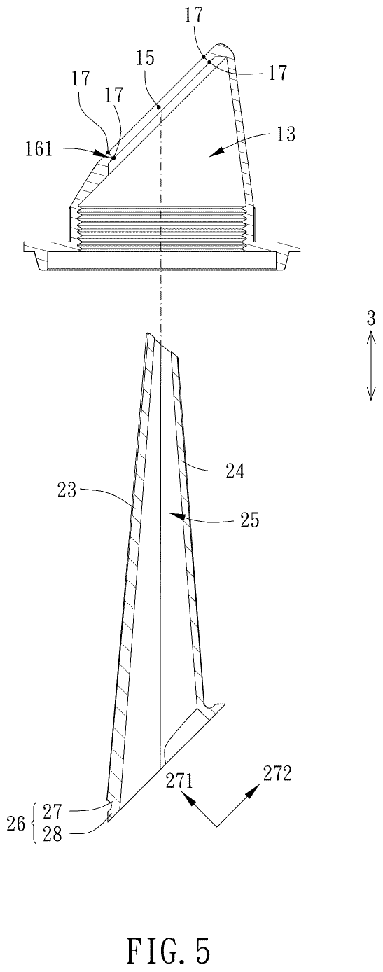

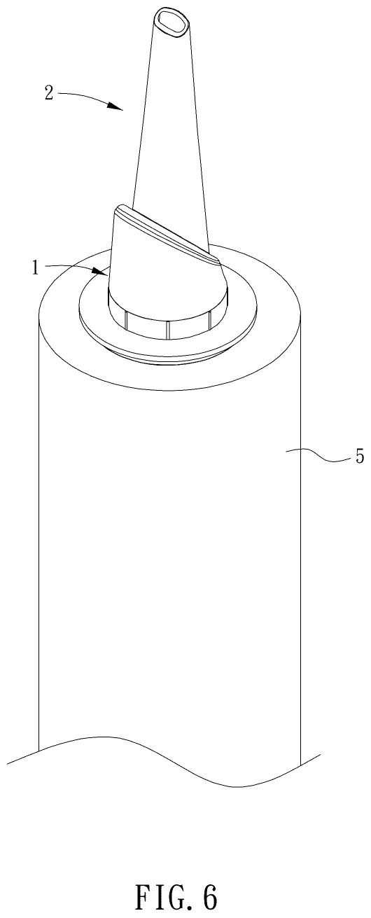

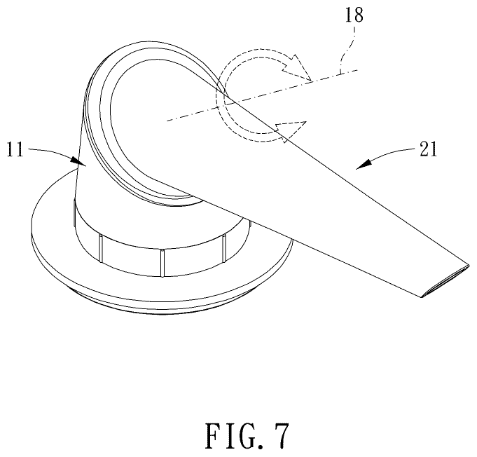

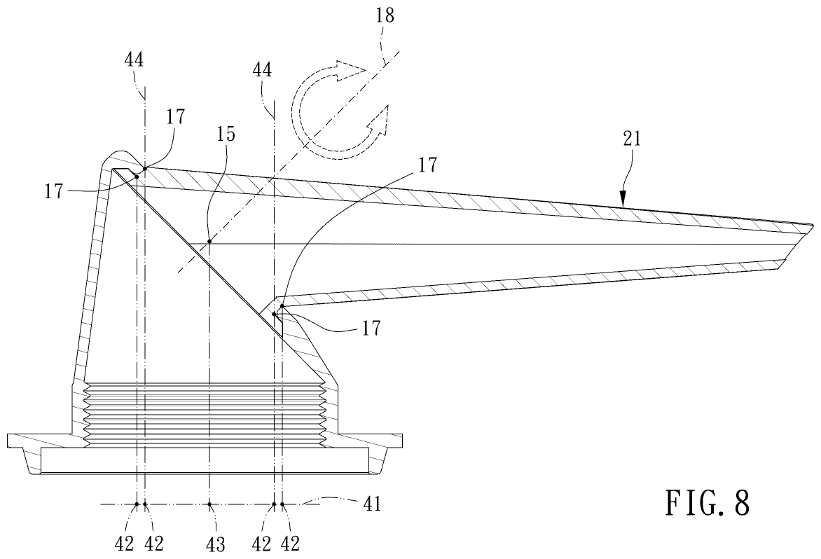

Please refer to FIGS. 1 to 8 for an exemplary embodiment of the present invention. An adjustable nozzle of the present invention includes a first member 1 and a second member 2.

The first member 1 includes a first body 11, a first channel 13 and a first opening 14. The first body 11 is configured to be connected to a container 5 (such as a cartridge for containing silicone). The first channel 13 extends through the first body 11 in a first direction 3 and is configured to be in communication with the interior of the container 5, and the first direction 3 is inclined relative to a direction toward which the first opening 14 is open. The first opening 14 is disposed on an inclined end surface 12 of the first body 11. The first body 11 further includes an annular flange 19 extending on a side of the first body 11 away from the first opening 14. In a direction perpendicular to the first direction 3, the first channel 13 has a diametric dimension greater than a maximum outer diametric dimension of the second member 2, which is conducive to the assembly of the second member 2.

The second member 2 includes a second body 21, a second channel 25, and an engaging portion 26. The length of the second body 21 is greater than the length of the first body 11, and the second body 21 tapers in the direction away from the engaging portion 26 to facilitate insertion into narrow spaces. The second channel 25 extends through the second body 21, and the engaging portion 26 is disposed on the second body 21. When the second body 21 is disposed through the first channel 13 and protrudes out of the first opening 14, the second body 21 is rotatable relative to the first body 11, allowing the second body 21 to extend into narrow spaces and corners. The engaging portion 26 is located in the first channel 13 and interlocks with an edge 16 of the first opening 14 in the first direction 3, effectively preventing the first member 1 from detaching from the second member 2 due to internal fluid flow pressure during use. The second channel 25 is in communication with the first channel 13, enabling fluid located within the container 5 to flow through the first channel 13 and the second channel 25 to the outside.

Specifically, the second body 21 is rotatable relative to the first body 11 about a rotation axis 18 defined by a centerline of the first opening 14, enabling free rotation. This configuration provides various usability and broad accessibility, making it applicable to various environments. The extension direction of the first body 11, the extension direction of the second body 21 and the first direction 3 are all transverse to the rotation axis 18.

The first body 11 includes an inclined end surface 12 transverse to the first direction 3. The first opening 14 is disposed on the inclined end surface 12. In a cross-sectional view of the first body 11, a plurality of boundary projection points 42 are defined by projecting a plurality of endpoints of the edge 16 of the first opening 14 in the first direction 3 onto a reference plane 41. A center projection point 43 is defined by projecting a center point 15 of the first opening 14 in the first direction 3 onto the reference plane 41. Two boundary lines 44 parallel to the first direction 3 pass through two of the plurality of boundary projection points 42 which are located by opposite sides of the center projection point 43. A portion of the second body 21 protruding out of the inclined end surface 12 extends beyond only one of the two boundary lines 44.

With the first body 11 and the second body 21 being assembled in the aforementioned structural arrangement, the second body 21 can smoothly extend through the first opening 14 in the first direction 3 and maintain stable assembly with the first body 11 during relative rotation. When not in use, the second body 21 can be smoothly withdrawn from the first opening 14 in the first direction 3, facilitating easy separation for storage or replacement. In this embodiment, when the second body 21 is rotated so that an extension direction of the second body 21 is parallel to the first direction 3 or when the second body 21 is rotated so that an extension direction of the second body 21is perpendicular to the first direction 3, the second body 21 protrudes beyond a same one of the two boundary lines 44.

The engaging portion 26 includes a connection portion 27 and a blocking portion 28. The connection portion 27 defines an axial direction 271 and a radial direction 272. The second body 21 extends transversely to the axial direction 271 from an end of the connection portion 27. The blocking portion 28 extends radially outward from an other end of the connection portion 27. The connection portion 27 is inserted in the first opening 14, and the blocking portion 28 is located within the first channel 13 to interlock with the edge 16 of the first opening 14 in the first direction 3. This structure ensures a secure engagement between the first member 1 and the second member 2 while maintaining rotational functionality.

Preferably, the edge 16 of the first opening 14 includes a chamfer 161 on a side facing the first channel 13. A contour of the portion of the connection portion 27 which interconnects with the blocking portion 28 matches a contour of the chamfer 161. This matching contour design facilitates smooth assembly and enhances the structural integrity of the nozzle.

Preferably, a portion of the second member 2 protruding out of the first opening 14 is not pressed against the first member 1 in the direction toward which the first opening 14 is open. This configuration reduces friction and wear between the first member 1 and the second member 2 during rotation, thereby extending the operational lifespan of the nozzle. Furthermore, when the second member 2 is withdrawn from the first opening 14 and separated from the first member 1 in the first direction 3, the structural arrangement that the second member 2 is not pressed against the first member 1 prevents unnecessary interlocking interference.

Preferably, a second opening 22 of the second body 21 remote from the engaging portion 26 is inclined so that the second body 21 can contact the surface to be processed in surface contact. The second opening 22 is non-circular. The second opening 22 is in communication with the second channel 25. The second body 21 includes a first side wall 23 and a second side wall 24. The first side wall 23 is located relatively higher than the second side wall 24. The first side wall 23 and the second side wall 24 are connected to each other and form the second channel 25 and the second opening 22. The first side wall 23 has a minimum thickness not less than a minimum thickness of the second side wall 24, ensuring structural stability and durability. In this embodiment, the thickness of the first side wall 23 gradually decreases from the engaging portion 26 toward the second opening 22, and the second side wall 24 has a fixed thickness

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An adjustable nozzle including:
a first member including a first body, a first channel and a first opening, the first channel extending through the first body in a first direction, the first direction being inclined relative to a direction toward which the first opening is open; and
a second member including a second body, a second channel and an engaging portion, the second channel extending through the second body, the engaging portion being disposed on the second body, wherein when the second body is disposed through the first channel and protrudes out of the first opening, the second body is rotatable relative to the first body, the engaging portion is located in the first channel and interlocks with an edge of the first opening in the first direction, and the second channel is in communication with the first channel.

2. The adjustable nozzle of claim 1, wherein the second body is rotatable relative to the first body about a rotation axis defined by a centerline of the first opening.

3. The adjustable nozzle of claim 2, wherein an extension direction of the first body, an extension direction of the second body and the first direction are transverse to the rotation axis.

4. The adjustable nozzle of claim 1, wherein the engaging portion includes a connection portion and a blocking portion, the connection portion defines an axial direction and a radial direction, the second body extends transversely to the axial direction from an end of the connection portion, the blocking portion extends radially outward from an other end of the connection portion, the connection portion is inserted in the first opening, and the blocking portion is located in the first channel to interlock with the edge of the first opening in the first direction.

5. The adjustable nozzle of claim 4, wherein the edge of the first opening includes a chamfer on a side facing the first channel, and a contour of a portion of the connection interconnecting with the blocking portion matches a contour of the chamfer.

6. The adjustable nozzle of claim 1, wherein a portion of the second member protruding out of the first opening is not pressed against the first member in the direction toward which the first opening is open.

7. The adjustable nozzle of claim 1, wherein a second opening of the second body remote from the engaging portion is inclined, the second opening is in communication with the second channel, the second body includes a first side wall and a second side wall which is located relatively lower than the first side wall, the first side wall and the second side wall are connected to each other and form the second channel and the opening, and the first side wall has a minimum thickness not less than a minimum thickness of the second side wall.

8. The adjustable nozzle of claim 1, wherein the first body further includes an inclined end surface transverse to the first direction, the first opening is disposed on the inclined end surface, in a cross-sectional view of the first body, a plurality of boundary projection points are defined by that a plurality of endpoints of the edge of the first opening are projected in the first direction onto a reference plane, a center projection point is defined by that a center point of the first opening is projected in the first direction onto the reference plane, two boundary lines parallel to the first direction pass through two of the plurality of boundary projection points which are located by opposite sides of the center projection point, and a portion of the second body protruding out of the inclined end surface extends beyond only one of two boundary lines.

9. The adjustable nozzle of claim 8, wherein when the second body is rotated so that an extension direction of the second body is parallel to the first direction or when the second body is rotated so that the extension direction of the second body is perpendicular to the first direction, the second body protrudes beyond a same one of the two boundary lines.

10. The adjustable nozzle of claim 3, wherein the engaging portion includes a connection portion and a blocking portion, the connection portion defines an axial direction and a radial direction, the second body extends transversely to the axial direction from an end of the connection portion, the blocking portion extends radially outward from an other end of the connection portion, the connection portion is inserted in the first opening, and the blocking portion is located in the first channel to interlock with the edge of the first opening in the first direction; a portion of the second member protruding out of the first opening is not pressed against the first member in the direction toward which the first opening is open; the first opening is circular; a second opening of the second body remote from the engaging portion is inclined, the second opening is in communication with the second channel, the second body includes a first side wall and a second side wall which is located relatively lower than the first side wall, the first side wall and the second side wall are connected to each other and form the second channel and the opening, and the first side wall has a minimum thickness not less than a minimum thickness of the second side wall; the first body further includes an inclined end surface transverse to the first direction, the first opening is disposed on the inclined end surface, in a cross-sectional view of the first body, a plurality of boundary projection points are defined by that a plurality of endpoints of the edge of the first opening are projected in the first direction onto a reference plane, a center projection point is defined by that a center point of the first opening is projected in the first direction onto the reference plane, two boundary lines parallel to the first direction pass through two of the plurality of boundary projection points which are located by opposite sides of the center projection point, and a portion of the second body protruding out of the inclined end surface extends beyond only one of two boundary lines; when the second body is rotated so that an extension direction of the second body is parallel to the first direction or when the second body is rotated so that the extension direction of the second body is perpendicular to the first direction, the second body protrudes beyond a same one of the two boundary lines; in a direction perpendicular to the first direction, the first channel has a diametric dimension greater than a maximum outer diametric dimension of the second member; the second body tapers in the direction away from the engaging portion; the thickness of the first side wall gradually decreases from the engaging portion toward the second opening, and the second side wall has a fixed thickness; the second body is longer than the first body; the second opening is non-circular; the first body further includes an annular flange extending on a side of the first body away from the first opening.
